(19) United States
(12) Patent Application Publication
(10) Pub. No.: US 2012/0262647 A1
(43) Pub. Date: Oct. 18, 2012

(54) Liquid Crystal Display and Backlight Module Employed Therein

(76) Inventors: Che-Chang Hu, Shenzhen City (CN); Hu He, Shenzhen City (CN)

(21) Appl. No.: 13/260,364

(22) PCT Filed: May 19, 2011
(86) PCT No.: PCT/CN11/74360

§ 371 Date: Sep. 25, 2011

(30) Foreign Application Priority Data
Apr. 14, 2011 (CN) 201110093919.6

(51) Int. Cl. F21V 8/00; G02F 1/1337

(52) U.S. Cl. 349/65; 362/613; 362/612

(57) ABSTRACT

The present disclosure provides a backlight module. The backlight module includes a light guide plate and a light bar. The light guide plate includes a light incident surface, and the light bar is adjacent to the light incident surface. The light bar includes a printed circuit board and a plurality of point light sources alternately located on the printed circuit board. Each point light source includes an illuminator and an encapsulation apparatus. The encapsulation apparatus encapsulates the illuminator and fixes the light guide plate for limiting a distance between the light incident surface and the illuminator. The present disclosure also provides a liquid crystal display employing the backlight module.

### TECHNICAL FIELD

The present disclosure relates to display devices, and more particularly relates to a liquid crystal display (LCD) and a backlight module employed in the liquid crystal display.

### BACKGROUND

A liquid crystal display generally includes a backlight module and a liquid crystal panel stacked with the backlight module. Liquid crystal material in the liquid crystal panel does not emit any light beam itself. Therefore, the backlight module is required in the liquid crystal display to provide light beams for the liquid crystal panel. A light emitting diode (LED) is used as a representative point light source and is generally used in the backlight module as a key component. Generally, a plurality of light emitting diodes are arrayed on a surface of a printed circuit board (PCB), thereby forming a light emiting diode light bar. The plurality of light emiting diodes are driven by the printed circuit board to emit light beams and form a linear light source. The linear light source is further converted into a planar light source after guided by a light guide plate (LGP) of the backlight module.

Referring to FIG. 1, FIG. 1 is a schematic, side view of a conventional backlight module. As shown in FIG. 1, the backlight module 100 includes a light emiting diode 120 and a light guide plate 110. A thickness of the light emiting diode 120 is approximate to that of the light guide plate 110. The light guide plate 110 includes a light incident surface 112. A distance between the light emiting diode 120 and the light incident surface 112 of the light guide plate 110 is a main factor of light beam coupling efficiency.

Generally, the distance between the light emiting diode 120 and the light incident surface 112 of the light guide plate 110 depends on many factors. For example, the light guide plate 110 is conventionaly made from polymethyl methacrylate (PMMA), which has a high ratio of water absorption and is easily distorted with heat. Moreover, the light guide plate 110 is generally fixed by a back cover (not shown) of the backlight module 100 or other members. Assembly tolerances and self tolerances of the back cover and the light guide plate 110 may result in an improper distance between the light emiting diode 120 and the light incident surface 112 of the light guide plate 110. When this occurs, a light beam coupling efficiency of the backlight module 100 is unduly affected.

### SUMMARY

Accordingly, the present disclosure provides a backlight module and a liquid crystal display employing the backlight module which may improve the light beam coupling efficiency of the backlight module.

A backlight module provided in the present disclosure includes a light guide plate and a light bar. The light guide plate includes a light incident surface. The light bar is adjacent to the light incident surface. The light bar includes a printed circuit board and a plurality of point light sources alternately located on the printed circuit board. Each point light source includes an illuminator and an encapsulation apparatus. The encapsulation apparatus includes an accommodating portion, two opposite extending portions and two blocking portions. The accommodating portion accommodates the illuminator. The extending portions and the accommodating portion cooperatively define a groove. The two blocking portions are located at ends of the two extending portions which connect with the accommodating portion and form a stepped structure with the extending portions. The blocking portions fittingly press the light incident surface of the light guide plate accommodated in the groove to limit a distance between the light incident surface and the illuminator.

A backlight module provided in the present disclosure includes a light guide plate and a light bar. The light guide plate includes a light incident surface. The light bar is adjacent to the light incident surface. The light bar includes a printed circuit board and a plurality of point light sources alternately located on the printed circuit board. Each point light source includes an illuminator and an encapsulation apparatus. The encapsulation apparatus encapsulates the illuminator and fixes the light guide plate for limiting a distance between the light incident surface and the illuminator.

Preferably, the plurality of illuminators are light emitting diodes.

Preferably, the encapsulation apparatus includes an accommodating portion, two opposite extending portions and two blocking portions. The accommodating portion accommodates the illuminator. The extending portions and the accommodating portion cooperatively define a groove. The two blocking portions are located at ends of the two extending portions which connect with the accommodating portion and form a stepped structure with the extending portions. The blocking portions fittingly press the light incident surface of the light guide plate accommodated in the groove to limit the distance between the light incident surface and the illuminator.

Preferably, the groove has a width corresponding to a thickness of the light guide plate for holding the light guide plate.

Preferably, the accommodating portion, the extending portions and the blocking portion are integrally formed as a whole to form the encapsulation apparatus.

Preferably, the encapsulation apparatus is made from polyphthalamide.

A liquid crystal display provided in the present disclosure includes a liquid crystal panel and a backlight module located adjacent to the liquid crystal panel. The backlight module includes a light guide plate and a light bar. The light guide plate includes a light incident surface. The light bar is adjacent to the light incident surface. The light bar includes a printed circuit board and a plurality of point light sources alternately located on the printed circuit board. Each point light source includes an illuminator and an encapsulation apparatus. The encapsulation apparatus encapsulates the illuminator and fixes the light guide plate for limiting a distance between the light incident surface and the illuminator.

Compared with typical backlight modules, the encapsulation apparatuses of the point light source of the backlight module of the present disclosure may directly fixing the light guide plate to limit the distance between the illuminator and the light incident surface of the light guide plate, which results in greatly optimized light beam coupling efficiency of the backlight module.

### BRIEF DESCRIPTION OF THE DRAWINGS

The components in the drawings are not necessarily drawn to scale, the emphasis instead being placed upon clearly illustrating the principles of at least one embodiment of the present disclosure. In the drawings, like reference numerals designate corresponding parts throughout various views, and all the views are schematic.

FIG. 1 is a schematic, side view of a typical backlight module.

FIG. 2 is a schematic, side view of a backlight module according to an exemplary embodiment of the present disclosure.

FIG. 3 is a schematic, perspective view of a light bar of the backlight module of FIG. 2.

FIG. 4 is a schematic, perspective view of an encapsulation apparatus of the backlight module of FIG. 2.

FIG. 5 is a schematic, side view of a liquid crystal display according to an exemplary embodiment of the present disclosure.

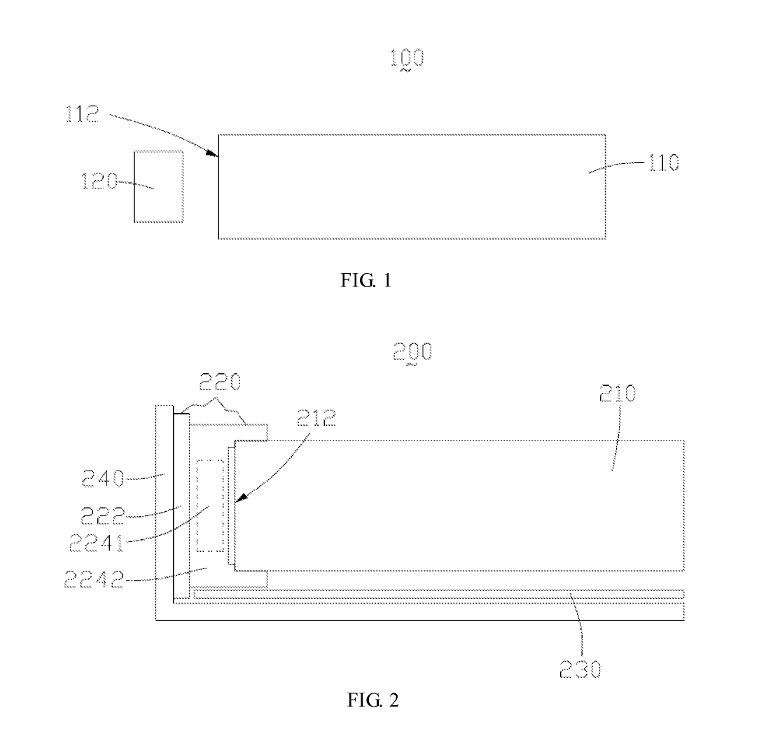

### DETAILED DESCRIPTION OF EMBODIMENTS

Reference will now be made to the drawings to describe preferred and exemplary embodiments of the present disclosure in detail.

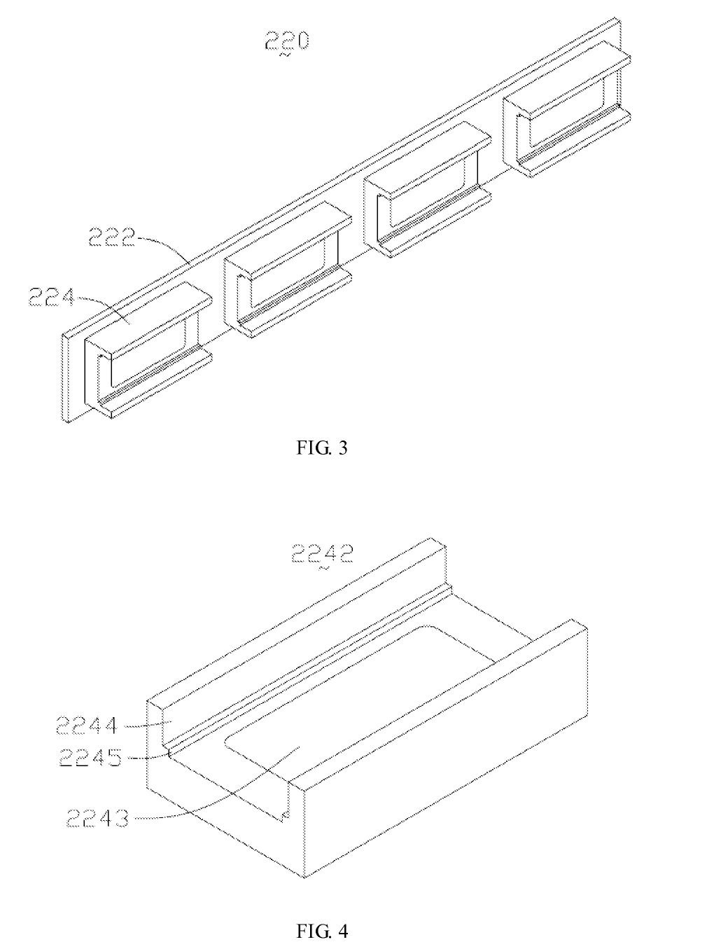

Referring to FIG. 2 and FIG. 3, the present disclosure provides a backlight module 200. The backlight module 200 includes a light guide plate 210 and a light bar 220.

The light guide plate 210 includes a light incident surface 212, and the light bar 220 is located adjacent to the light incident surface 212. The light bar 220 includes a printed circuit board 222 and a plurality of point light sources 224 alternately located on the printed circuit board 222. Each point light source 224 includes an illuminator 2241 and an encapsulation apparatus 2242. The encapsulation apparatus 2242 is configured for encapsulating the illuminator 2241 and fixing the light guide plate 210 to limit a distance between the illuminator 2241 and the light incident surface 212.

In the illustrated embodiment, the plurality of illuminators 2241 are a plurality of alternately located light emiting diodes.

Referring to FIG. 4, the encapsulation apparatus 2242 includes an accommodating portion 2243 and two opposite extending portions 2244. The accommodating portion 2243 is defined for accommodating the illuminator 2241. The two extending portions 2244 and the accommodating portion 2243 cooperatively define a groove (not labeled). The groove has a width corresponding to a thickness of the light guide plate 210 for holding the light guide plate 210.

Moreover, two blocking portions 2245 are further integrally located in the encapsulation apparatus 2242. The two blocking portions 2245 are located at ends of the two extending portions 2244 which connect with the accommodating portion 2243, and form a stepped structure (not labeled) with the extending portions 2244. The blocking portions 2245 fittingly press the light incident surface 212 of the light guide plate 210 to limit the distance between the illuminator 2241 and the light incident surface 212.

Moreover, the backlight module 200 further includes a reflective film 230 located below the light guide plate 210 and the encapsulation apparatuses 2242, and a back frame 240 for accommodating the encapsulation apparatuses 2242 and the reflective film 230. The reflective film 230 and the back frame 240 are not the key points of the present disclosure, and may refer to typical disclosures.

Compared with typical backlight modules, the encapsulation apparatuses 2242 of the point light source 224 of the backlight module 200 of the present disclosure directly fix the light guide plate 210 to limit the distance between the illuminator 2241 and the light incident surface 212 of the light guide plate 210. This results in greatly an optimized light beam coupling efficiency of the backlight module 200.

Moreover, because the point light sources 224 are alternately located on the printed circuit board 222, there are clearances between the encapsulation apparatuses 2242 when one or more encapsulation apparatuses 2242 are configured for fixing the light guide plate 210. Therefore, improved air thermal effect may be achieved when a temperature of the light guide plate 210 is relatively high. The accommodating portion 2243, the extending portions 2244 and the blocking portion 2245 are integrally formed as a whole to form the encapsulation apparatuses 2242, which is easy to be manufactured with a lower cost, without additional assembly. In the illustrated embodiment of the present disclosure, the encapsulation apparatus 2242 may be made from polyphthalamide (PPA). A distortion temperature of the PPA material is over 300° C., and a continue-working temperature may be 170° C. Therefore, the PPA material may keep outstanding mechanical characteristic such as intensity, rigidity, fatigue durability, and so on. Furthermore, water absorbability of the PPA material has is relatively low. Therefore, the encapsulation apparatus 2242 made from PPA for fixing the light guide plate 210 may further improve the light beam coupling efficiency of the backlight module 200.

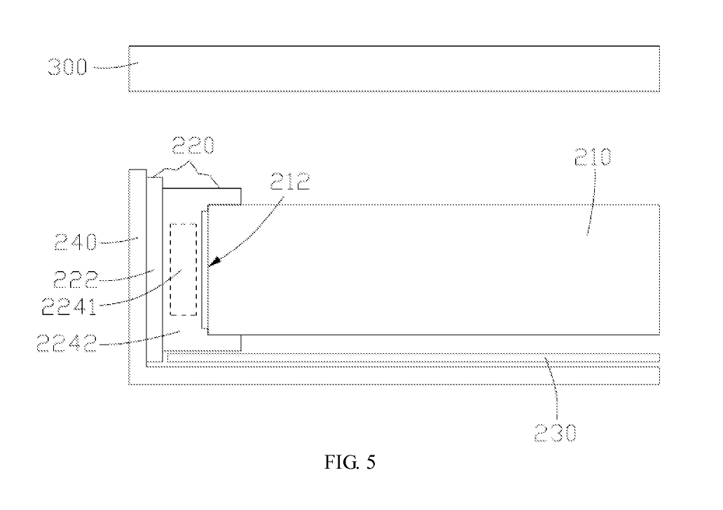

Referring to FIG. 5, a liquid crystal display 10 of the present disclosure includes a backlight module 200 which has been described above and a liquid crystal panel 300. The backlight module 200 is located adjacent to the liquid crystal panel 300.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A backlight module, comprising:
a light guide plate, the light guide plate comprising a light incident surface; and
a light bar, the light bar being adjacent to the light incident surface, the light bar comprising a printed circuit board and a plurality of point light sources alternately located on the printed circuit board;
wherein each point light source comprises:
an illuminator; and
an encapsulation apparatus, the encapsulation apparatus comprising an accommodating portion, two opposite extending portions and two blocking portions, the accommodating portion accommodating the illuminator, the extending portions and the accommodating portion cooperatively defining a groove, the two blocking portions being located at ends of the two extending portions which connect with the accommodating portion and forming a stepped structure with the extending portions, the blocking portions fittingly pressing the light incident surface of the light guide plate accommodated in the groove to limit a distance between the light incident surface and the illuminator.

2. A backlight module comprising a light guide plate and a light bar, the light guide plate comprising a light incident surface, the light bar being adjacent to the light incident surface, the light bar comprising a printed circuit board and a plurality of point light sources alternately located on the printed circuit board, wherein each point light source comprises an illuminator and an encapsulation apparatus, and the encapsulation apparatus encapsulates the illuminator and fixes the light guide plate for limiting a distance between the light incident surface and the illuminator.

3. The backlight module of claim 2, wherein the plurality of illuminators are light emitting diodes.

4. The backlight module of claim 3, wherein the encapsulation apparatus comprises an accommodating portion, two opposite extending portions and two blocking portions, the accommodating portion accommodating the illuminator, the extending portions and the accommodating portion cooperatively defining a groove, the two blocking portions being located at ends of the two extending portions which connect with the accommodating portion and forming a stepped structure with the extending portions, the blocking portions fittingly pressing the light incident surface of the light guide plate accommodated in the groove to limit the distance between the light incident surface and the illuminator.

5. The backlight module of claim 4, wherein the groove has a width corresponding to a thickness of the light guide plate for holding the light guide plate.

6. The backlight module of claim 5, wherein the accommodating portion, the extending portions and the blocking portions are integrally formed as a whole to form the encapsulation apparatus.

7. The backlight module of claim 6, wherein the encapsulation apparatus is made from polyphthalamide.

8. A liquid crystal display comprising a liquid crystal panel and a backlight module located adjacent to the liquid crystal panel, the backlight module comprising a light guide plate and a light bar, the light guide plate comprising a light incident surface, the light bar being adjacent to the light incident surface, the light bar comprising a printed circuit board and a plurality of point light sources alternately located on the printed circuit board, wherein each point light source comprises an illuminator and an encapsulation apparatus, and the encapsulation apparatus encapsulates the illuminator and fixes the light guide plate for limiting a distance between the light incident surface and the illuminator.

9. The liquid crystal display of claim 8, wherein the plurality of illuminators are light emitting diodes.

10. The liquid crystal display of claim 8, wherein the encapsulation apparatus comprises an accommodating portion, two opposite extending portions and two blocking portions, the accommodating portion accommodating the illuminator, the extending portions cooperatively defining a groove, the two blocking portions being located at ends of the two extending portions which connect with the accommodating portion and forming a stepped structure with the extending portions, the blocking portions fittingly pressing the light incident surface of the light guide plate accommodated in the groove to limit the distance between the light incident surface and the illuminator.

11. The liquid crystal display of claim 10, wherein the groove has a width corresponding to a thickness of the light guide plate for holding the light guide plate.

12. The liquid crystal display of claim 11, wherein the accommodating portion, the extending portions and the blocking portions are integrally formed as a whole to form the encapsulation apparatus.

13. The liquid crystal display of claim 12, wherein the encapsulation apparatus is made from polyphthalamide.
